(19) United States
(12) Patent Application Publication
(10) Pub. No.: US 2021/0133561 A1
(43) Pub. Date: May 6, 2021

(54) ARTIFICIAL INTELLIGENCE DEVICE AND METHOD OF OPERATING THE SAME

(71) Applicant: LG ELECTRONICS INC., Seoul (KR)

(72) Inventor: Esther YOON, Seoul (KR)

(73) Assignee: LG ELECTRONICS INC., Seoul (KR)

(21) Appl. No.: 16/742,698

(22) Filed: Jan. 14, 2020

(30) Foreign Application Priority Data
Nov. 5, 2019 (KR) 10-2019-0140408

(51) Int. Cl. G06N 3/08; G06N 5/02

(52) U.S. Cl. CPC G06N 3/08; G06N 5/02

(57) ABSTRACT

An artificial intelligence device may acquire fine dust flow information indicating change in fine dust state over time in a space, in which an air cleaner is located, based on weather information and a fine dust information set, determine an operation time of the air cleaner based on the acquired fine dust flow information, and transmit a notification for requesting operation at the determined operation time to the air cleaner via a communication interface.

### CROSS-REFERENCE TO RELATED APPLICATIONS

Pursuant to 35 U.S.C. § 119(a), this application claims the benefit of earlier filing date and right of priority to Korean Patent Application No. 10-2019-0140408, filed on Nov. 5, 2019, the contents of which are all hereby incorporated by reference herein in its entirety.

### BACKGROUND

The present disclosure relates to an artificial intelligence (AI) device capable of detecting fine dust flow.

In general, when a person stays for a long time in a room of a building which is not well ventilated, the room cannot be maintained in a comfortable state due to increase of CO2 and fine dust. Therefore, the room needs to be ventilated.

Recently, air cleaners have been mainly used to clean indoor air.

In particular, an in-house air cleaner is disposed in a living room or a main room.

Conventionally, a user determined whether a fine dust state is not good and operated an air cleaner when the fine dust state is not good.

However, since the air cleaner operates in a state in which a fine dust concentration is already high, the fine dust may adversely affect user's breathing until the fine dust concentration is lowered.

### SUMMARY

An object of the present disclosure is to provide an artificial intelligence device capable of operating an air cleaner in advance before a fine dust state is changed to a bad state, in consideration of the weather and fine dust state of the surroundings.

Another object of the present disclosure is to provide an artificial intelligence device capable of predicting fine dust flow and determining an operation time of an air cleaner.

An artificial intelligence device according to the present disclosure may acquire fine dust flow information indicating change in fine dust state over time in a space, in which an air cleaner is located, based on weather information and a fine dust information set, determine an operation time of the air cleaner based on the acquired fine dust flow information, and transmit a notification for requesting operation at the determined operation time to the air cleaner via a communication interface.

The artificial intelligence device according to the present disclosure may determine a time earlier than the certain time as the operation time of the air cleaner, when the fine dust state is predicted to be changed to a bad state after the certain time.

### BRIEF DESCRIPTION OF THE DRAWINGS

The present disclosure will become more fully understood from the detailed description given herein below and the accompanying drawings, which are given by illustration only, and thus are not limitative of the present disclosure, and wherein:

FIG. 1 illustrates an AI device 100 according to an embodiment of the present disclosure;

FIG. 2 illustrates an AI server 200 according to an embodiment of the present disclosure;

FIG. 3 illustrates an AI system 1 according to an embodiment of the present disclosure;

FIG. 4 illustrates an AI device 100 according to an embodiment of the present disclosure;

FIG. 5 is a ladder diagram illustrating a method of operating a system according to an embodiment of the present disclosure;

FIG. 6 is a view illustrating the configuration of a system according to an embodiment of the present disclosure;

FIGS. 7 and 8 are views illustrating a process of acquiring fine dust flow information based on weather information and a fine dust information set according to an embodiment of the present disclosure;

FIG. 9 is a view illustrating an example in which an artificial intelligence device outputs a notification including information on an operation time of an air cleaner according to an embodiment of the present disclosure;

FIG. 10 is a ladder diagram illustrating a method of operating a system according to another embodiment of the present disclosure; and

FIG. 11 is a view illustrating an air quality state prediction model according to an embodiment of the present disclosure.

### DETAILED DESCRIPTION OF THE EMBODIMENTS

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the disclosure in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, if one part (or element, device, etc.) is referred to as being ‘connected’ to another part (or element, device, etc.), it should be understood that the former may be ‘directly connected’ to the latter, or ‘electrically connected’ to the latter via an intervening part (or element, device, etc.). It will be further understood that if one component is referred to as being ‘directly connected’ or ‘directly linked’ to another component, it means that no intervening component is present.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network may be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer if the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving device may include an actuator or a motor and may perform various physical operations such as moving a robot joint. In addition, a movable robot may include a wheel, a brake, a propeller, and the like in a driving device, and may travel on the ground through the driving device or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined path, and a technology for automatically setting and traveling a path if a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

In this case, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are illustrated together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

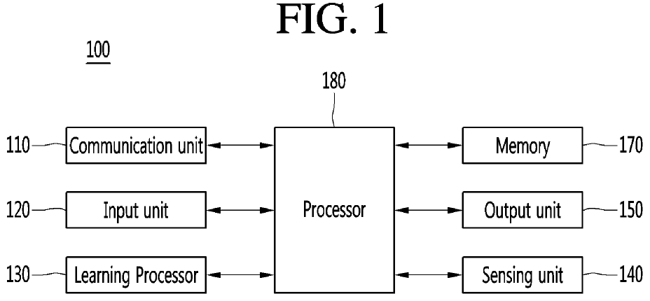

FIG. 1 illustrates an AI device 100 according to an embodiment of the present disclosure.

The AI device (or an AI apparatus) 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing device 140, an output device 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

In this case, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used if an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

In this case, the learning processor 130 may perform AI processing together with the learning processor 240 of the AI server 200.

In this case, the learning processor 130 may include a memory integrated or implemented in the AI device 100. Alternatively, the learning processor 130 may be implemented by using the memory 170, an external memory directly connected to the AI device 100, or a memory held in an external device.

The sensing device 140 may acquire at least one of internal information about the AI device 100, ambient environment information about the AI device 100, and user information by using various sensors.

Examples of the sensors included in the sensing device 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output device 150 may generate an output related to a visual sense, an auditory sense, or a haptic sense.

In this case, the output device 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

If the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

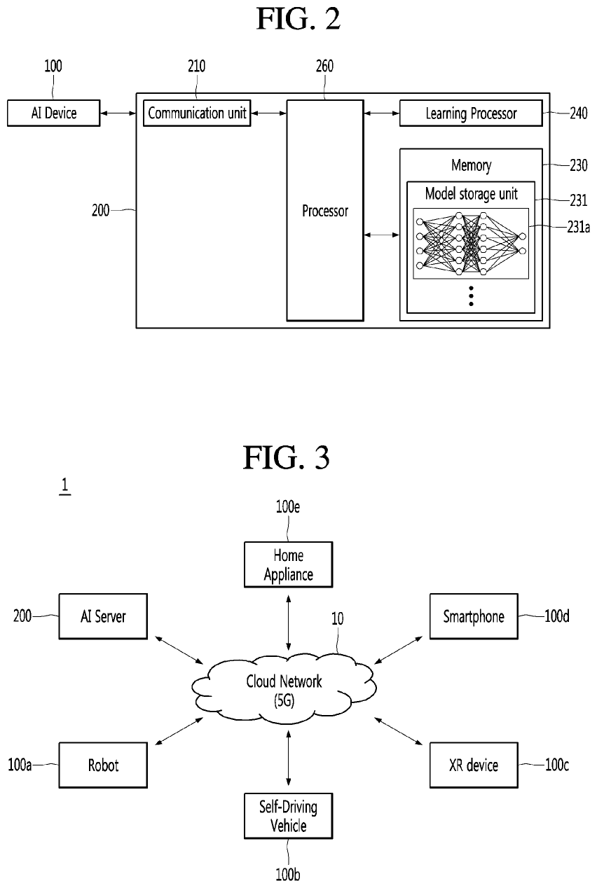

FIG. 2 illustrates an AI server 200 according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. In this case, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 may transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models is implemented in software, one or more instructions that constitute the learning model may be stored in memory 230.

The processor 260 may infer the result value for new input data by using the learning model and may generate a response or a control command based on the inferred result value.

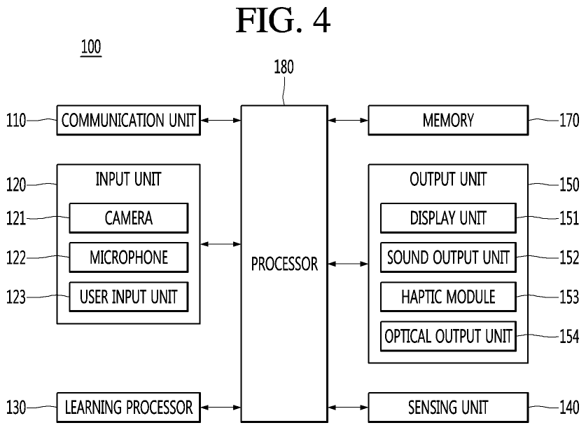

FIG. 3 illustrates an AI system 1 according to an embodiment of the present disclosure.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

In other words, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, In other words, the robot 100a, the self-driving vehicle 100b, the XR device 100c, the smartphone 100d, or the home appliance 100e through the cloud network 10, and may assist at least part of AI processing of the connected AI devices 100a to 100e.

In this case, the AI server 200 may learn the artificial neural network according to the machine learning algorithm instead of the AI devices 100a to 100e, and may directly store the learning model or transmit the learning model to the AI devices 100a to 100e.

In this case, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the path and the travel plan, may determine the response to user interaction, or may determine the operation.

The robot 100a may use the sensor information acquired from at least one sensor among the lidar, the radar, and the camera so as to determine the travel path and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

In this case, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel path and the travel plan, and may control the driving device such that the robot 100a travels along the determined travel path and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving device based on the control/interaction of the user. In this case, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the path and the travel plan, or may determine the operation.

Like the robot 100a, the self-driving vehicle 100b may use the sensor information acquired from at least one sensor among the lidar, the radar, and the camera so as to determine the travel path and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

In this case, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel path and the travel plan, and may control the driving device such that the self-driving vehicle 100b travels along the determined travel path and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving device based on the control/interaction of the user. In this case, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

In this case, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel path or the travel plan. For example, the robot 100a and the self-driving vehicle 100b having the self-driving function may determine at least one of the travel path or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

In this case, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, if it is determined that the driver is in a drowsy state, the robot 100a may activate the self-driving function of the self-driving vehicle 100b or assist the control of the driving device of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user may confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

In this case, if the XR object is output to the HUD, at least part of the XR object may be outputted so as to overlap the actual object to which the passenger's gaze is directed. Meanwhile, if the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

If the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

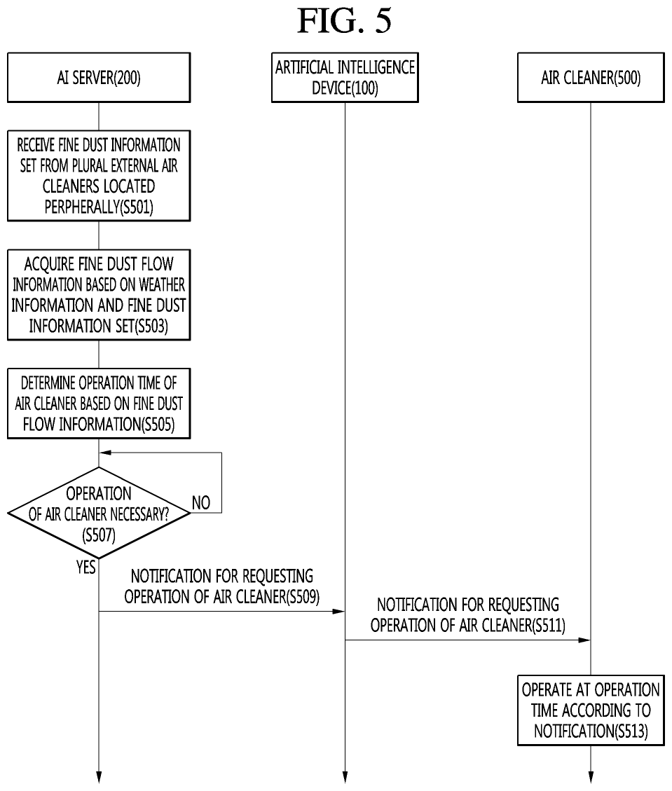

FIG. 4 illustrates an AI device according to another embodiment of the present disclosure.

The redundant repeat of FIG. 1 will be omitted below.

Referring to FIG. 4, a robot cleaner 500 may further include a driving device 160 and a cleaning unit 190, in addition to the components of FIG. 1.

The input unit 120 may include a camera 121 for image signal input, a microphone 122 for receiving audio signal input, and a user input unit 123 for receiving information from a user.

Voice data or image data collected by the input unit 120 are analyzed and processed as a user's control command.

Then, the input unit 120 is used for inputting image information (or signal), audio information (or signal), data, or information inputted from a user and the robot cleaner 500 may include at least one camera 121 in order for inputting image information.

The camera 121 processes image frames such as a still image or a video acquired by an image sensor in a video call mode or a capturing mode. The processed image frame may be displayed on the display unit 151 or stored in the memory 170.

The microphone 122 processes external sound signals as electrical voice data. The processed voice data may be utilized variously according to a function (or an application program being executed) being performed in the robot cleaner 500. Moreover, various noise canceling algorithms for removing noise occurring during the reception of external sound signals may be implemented in the microphone 122.

The user input unit 123 is to receive information from a user and if information is inputted through the user input unit 123, the processor 180 may control an operation of the robot cleaner 500 to correspond to the input information.

The user input unit 123 may include a mechanical input means (or a mechanical key, for example, a button, a dome switch, a jog wheel, and a jog switch at the front, back or side of the terminal 100) and a touch type input means. As one example, a touch type input means may include a virtual key, a soft key, or a visual key, which is displayed on a touch screen through software processing or may include a touch key disposed at a portion other than the touch screen.

The output device 150 may include at least one of a display unit 151, a sound output module 152, a haptic module 153, or an optical output module 154.

The display unit 151 may display (output) information processed in the robot cleaner 500. For example, the display unit 151 may display execution screen information of an application program running on the robot cleaner 500 or user interface (UI) and graphic user interface (GUI) information according to such execution screen information.

The display unit 151 may be formed with a mutual layer structure with a touch sensor or formed integrally, so that a touch screen may be implemented. Such a touch screen may serve as the user input unit 123 providing an input interface between the robot cleaner 500 and a user, and an output interface between the robot cleaner 500 and a user at the same time.

The sound output module 152 may output audio data received from the wireless communication unit 110 or stored in the memory 170 in a call signal reception or call mode, a recording mode, a voice recognition mode, or a broadcast reception mode.

The sound output module 152 may include a receiver, a speaker, and a buzzer.

The haptic module 153 generates various haptic effects that a user may feel. A representative example of a haptic effect that the haptic module 153 generates is vibration.

The optical output module 154 outputs a signal for notifying event occurrence by using light of a light source of the robot cleaner 500. An example of an event occurring in the robot cleaner 500 includes message reception, call signal reception, missed calls, alarm, schedule notification, e-mail reception, and information reception through an application.

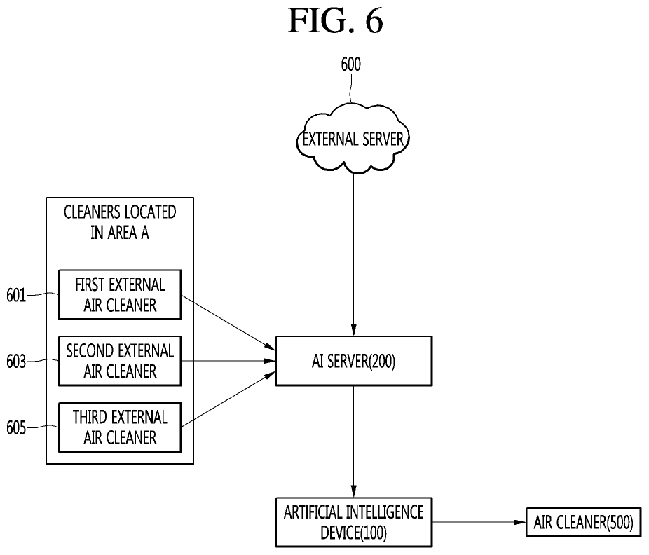

FIG. 5 is a ladder diagram illustrating a method of operating a system according to an embodiment of the present disclosure.

The system according to the embodiment of the present disclosure may include an artificial intelligence device 100, an AI server 200, and an air cleaner 500.

The air cleaner 500 may be located in a building or a house.

The air cleaner 500 may include all the components shown in FIG. 4.

The air cleaner 500 may be replaced with an air conditioner including an air cleaning function.

In addition, hereinafter, the communication unit 210 of FIG. 2 or the communication unit 110 of FIG. 4 may be referred to as a communication interface.

Referring to FIG. 5, the processor 260 of the AI server 200 receives a fine dust information set from a plurality of external air cleaners located peripherally via the communication unit 210 (S501).

Each of the plurality of external air cleaners may be located in the same area as the air cleaner 500.

According to one embodiment, instead of the external air cleaner, fine dust information may be received from a fine dust sensor capable of measuring fine dust or another home appliance.

Each of the plurality of external air cleaners may be located within a predetermined distance from the air cleaner 500. The predetermined distance may be at a radius of 1 km from the location of the air cleaner 500, but this is merely an example.

The present disclosure is described on the assumption that there is a plurality of external air cleaners, but this is merely an example. Fine dust information may be received from one external air cleaner.

The fine dust information set may include the fine dust information received from each of the plurality of external air cleaners.

For example, the fine dust information set may include first fine dust information received from a first external air cleaner, second fine dust information received from a second external air cleaner, and third fine dust information received from a third external air cleaner.

The fine dust information may include a fine dust concentration measured by each external air cleaner.

The fine dust concentration may be replaced with a ultrafine dust concentration.

Each external air cleaner may measure a fine dust concentration in real time or periodically and transmit the measured fine dust concentration to the AI server 200.

An air cleaning application for performing an in-house air management function may be installed in the artificial intelligence device 100.

The artificial intelligence device 100 may acquire information on the plurality of external air cleaners located within the predetermined distance from the location of the air cleaner 500 registered in the air cleaning application.

Information on each external air cleaner may include one or more of the location of the external air cleaner or identification information for identifying the external air cleaner.

The artificial intelligence device 100 may transmit information on the plurality of external air cleaners to the AI server 200.

The AI server 200 may request the fine dust information from each external air cleaner using the information on the plurality of external air cleaners received from the artificial intelligence device 100, and receive the fine dust information from each external air cleaner in response to the request.

The processor 260 of the AI server 200 acquires fine dust flow information based on weather information and the received fine dust information set (S503).

The processor 260 may acquire the weather information.

The processor 260 may acquire the weather information autonomously or from an external server.

The processor 260 may acquire the weather information via an application programming interface (API).

The weather information may include one or more of a wind direction, a wind speed, a temperature or a humidity measured in an area in which the air cleaner 500 is located.

The processor 260 may predict fine dust flow information based on the weather information and the fine dust information set received from the plurality of external air cleaners.

The fine dust flow information may be information indicating fine dust flow in a space in which the air cleaner 500 is located.

Specifically, the fine dust flow information may include hourly concentration change of fine dust.

The fine dust flow information may include hourly concentration change of fine dust predicted in a space in which the air cleaner 500 is located.

The fine dust flow information may include information indicating change in fine dust state over time in a space in which the air cleaner 500 is located.

Specifically, the fine dust flow information may include information indicating that the fine dust state is changed from a good state or a normal state to a bad state in the space in which the air cleaner 500 is located, after a certain time.

The processor 260 of the AI server 200 determines the operation time of the air cleaner 500 based on the fine dust flow information (S505).

The processor 260 may determine the operation time at which the air cleaner 500 performs air cleaning, using the fine dust flow information.

This will be described in detail below.

The processor 260 of the AI server 200 determines whether operation of the air cleaner 500 is necessary based on the determined operation time (S507).

The processor 260 may determine that operation of the air cleaner 500 is necessary, when the fine dust state of the space, in which the air cleaner 500 is located, is predicted to be changed to the bad state after a certain time, based on the fine dust flow information.

The fine dust state may include a good state, a normal state and a bad state.

Each state may be classified according to the fine dust concentration.

For example, when the fine dust concentration is less than a first level, the fine dust state may be a good state.

When the fine dust concentration is less than a second level greater than the first level and is equal to or greater than the first level, the fine dust state may be a normal state.

When the fine dust concentration is equal to or greater than the second level, the fine dust state may be a bad state.

Upon determining that operation of the air cleaner 500 is necessary, the processor 260 of the AI server 200 transmits a notification for requesting operation of the air cleaner 500 to the artificial intelligence device 100 via the communication unit 210 (S509).

For example, when the fine dust state is predicted to be changed to the bad state after a certain time in the space in which the air cleaner 500 is located, the processor 260 may transmit a notification for turning on the air cleaner 500 to the artificial intelligence device 100.

The notification may include an ON command for turning on the air cleaner 500 and an operation time at which the air cleaner 500 is turned on.

The processor 180 of the artificial intelligence device 100 transmits the notification received from the AI server 200 to the air cleaner 500 via the communication unit 110 (S511).

In one example, the artificial intelligence device 100 may automatically transmit the notification received from the AI server 200 to the air cleaner 500 without separate user input.

In another example, the processor 180 of the artificial intelligence device 100 may receive user input and transmits the notification to the air cleaner 500 according to the received user input.

The air cleaner 500 performs air cleaning operation at the operation time according to the notification received from the artificial intelligence device 100 (S513).

The air cleaner 500 may perform an air cleaning function based on the operation time included in the received notification.

When the operation time included in the received notification is a future time, the air cleaner 500 may make a reservation to automatically perform the air cleaning function at the operation time.

According to the embodiment of the present disclosure, based on the fine dust information measured by the external air cleaners located in the same area as the air cleaner 500, a time at which air cleaning is necessary may be predicted.

Therefore, it is possible to always optimize the fine dust state in the space in which the air cleaner 500 is located, by the air cleaning function of the air cleaner 500.

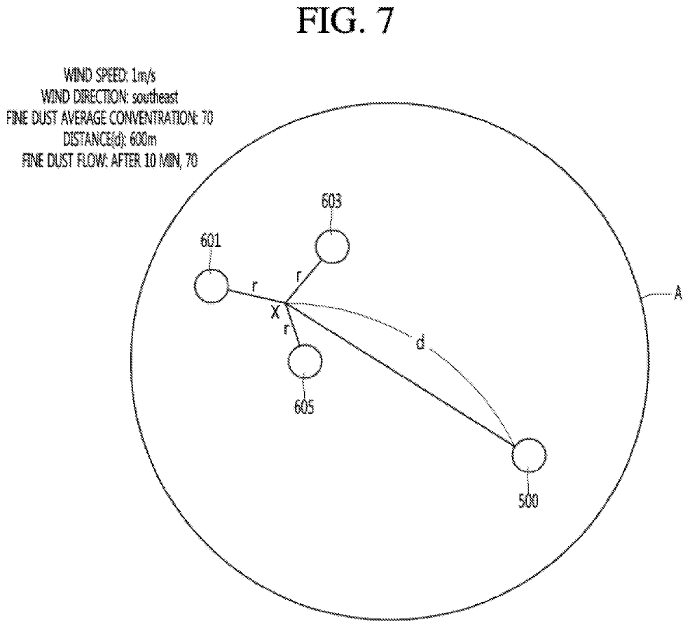

FIG. 6 is a view illustrating the configuration of a system according to an embodiment of the present disclosure.

Referring to FIG. 6, the system may include a plurality of external air cleaners 601 to 605, an external server 600, an AI server 200, an artificial intelligence device 100 and an air cleaner 500.

The plurality of external air cleaners 601 to 605 may be located in an area A in which the air cleaner 500 is located.

When the location of the air cleaner 500 is registered via the air cleaning application installed in the artificial intelligence device 100, each external air cleaner may be located within a certain radius from the air cleaner 500.

The AI server 200 may receive first fine dust information from the first external air cleaner 601, receive second fine dust information from the second external air cleaner 602, and receive third fine dust information from the third external air cleaner 605.

The AI server 200 may acquire fine dust flow information based on weather information and a fine dust information set received from the external server 600.

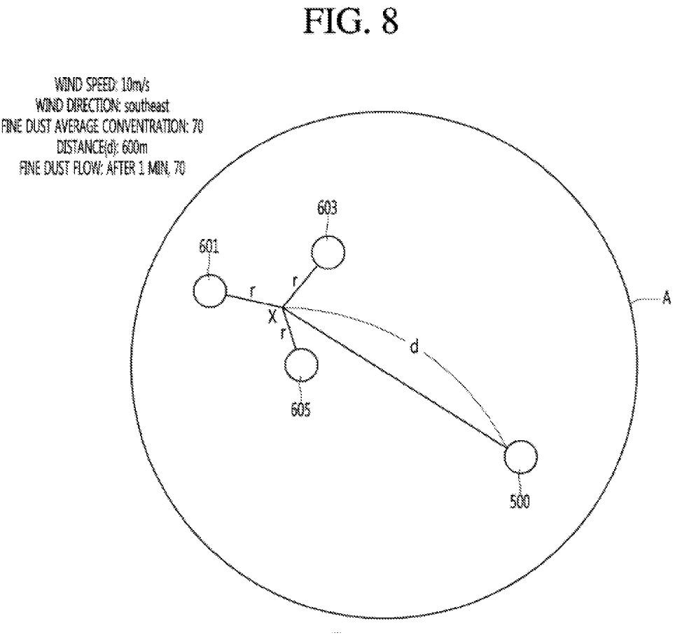

FIGS. 7 and 8 are views illustrating a process of acquiring fine dust flow information based on weather information and a fine dust information set according to an embodiment of the present disclosure.

Referring to FIGS. 7 and 8, the plurality of external air cleaners 601 to 605 located in the same area A as the air cleaner 500 is shown.

Assume that the distance d between each of the plurality of external air cleaners 601 to 605 and the air cleaner 500 is 50 m.

The distance d is a distance from any one point X to the air cleaner 500. The distances r between any one point X and the plurality of external air cleaners 601 to 605 may be the same.

In FIGS. 7 and 8, it is assumed that there are three external air cleaners, but this is merely an example. If only one external air cleaner is registered, the distance between the external air cleaner and the air cleaner 500 may be d.

First, FIG. 7 will be described.

In FIG. 7, it is assumed that the wind speed included in the weather information 1 m/s, the wind direction is southeast, and the average concentration of fine dust is 70.

The average concentration of fine dust may be an average value of a first fine dust concentration received from the first external air cleaner 601, a second fine dust concentration received from the second external air cleaner 603 and a third fine dust concentration received from the third external air cleaner 605.

The AI server 200 may predict the air quality state of the air cleaner 500 based on the wind speed, the wind direction and the distance d.

For example, when the wind direction and the average concentration of fine dust are continuously maintained, the AI server 200 may determine that the fine dust concentration of the space in which the air cleaner 500 is located is 70 after 10 minutes, by 600 m/1 (m/s)=600 s.

That is, the fine dust flow information may include information on a fine dust concentration predicted after a specific time in the space in which the air cleaner 500 is located.

When the current fine dust concentration measured in the space in which the air cleaner 500 is located is 50 and the criterion of the bad state of fine dust is 65 or more, the AI server 200 may predict that the fine dust concentration of the space in which the air cleaner 500 is located would be changed from 50 to 70 and thus the fine dust state would be changed to the bad state, after 10 minutes.

When the fine dust concentration of the space in which the air cleaner 500 is located is predicted to be changed to the bad state after a certain time by the fine dust flow information, the AI server 200 may determine a time earlier than the certain time as the operation time of the air cleaner 500.

That is, when the fine dust concentration of the space in which the air cleaner 500 is located is predicted to be changed to the bad state 10 minutes after a current time, the AI server 200 may determine 5 minutes after the current time as the operation time of the air cleaner 500.

Therefore, it is possible to prevent the fine dust state from being changed to the bad state, by performing the air cleaning function in advance before the fine dust concentration of the space in which the air cleaner 500 is located is changed to the bad state.

Similarly, FIG. 8 will be described.

In FIG. 8, it is assumed that the wind speed included in the weather information is 10 m/s, the wind direction is southeast, and the average concentration of fine dust is 70.

The average concentration of fine dust may be an average value of the first fine dust concentration received from the first external air cleaner 601, the second fine dust concentration received from the second external air cleaner 603 and the third fine dust concentration received from the third external air cleaner 605.

The AI server 200 may predict the air quality state of the air cleaner 500 based on the wind speed, the wind direction and the distance d.

For example, when the wind direction and the average concentration of fine dust are continuously maintained, the AI server 200 may determine that the fine dust concentration of the space in which the air cleaner 500 is located is 70 after 1 minutes, by 600 m/10 (m/s)=60 s.

That is, the fine dust flow information may include information on the fine dust concentration predicted after a specific time in the space in which the air cleaner 500 is located.

When the current fine dust concentration measured in the space in which the air cleaner 500 is located is 50 and the criterion of the bad state of fine dust is 65 or more, the AI server 200 may predict that the fine dust concentration of the space in which the air cleaner 500 is located would be changed from 50 to 70 and thus the fine dust state would be changed to the bad state, after 1 minute.

When the fine dust concentration of the space in which the air cleaner 500 is located is predicted to be changed to the bad state 1 minute after the current time, the AI server 200 may determine the current time as the operation time of the air cleaner 500.

Therefore, it is possible to prevent the fine dust state from being changed to the bad state, by performing the air cleaning function in advance before the fine dust concentration of the space in which the air cleaner 500 is located is changed to the bad state.

The AI server 200 may transmit a notification including information on the operation time to the artificial intelligence device 100.

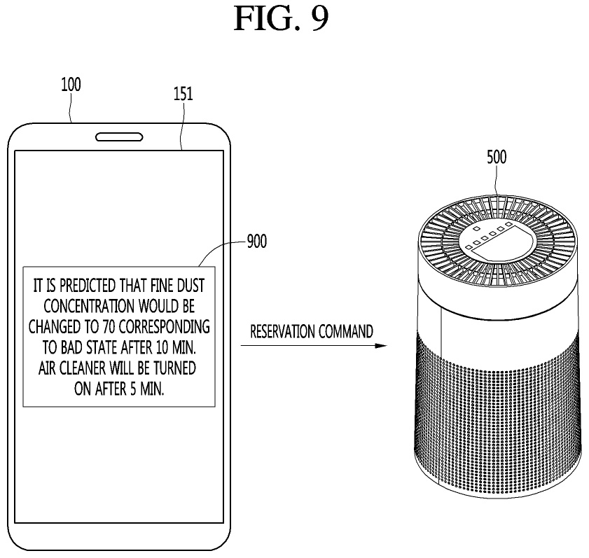

FIG. 9 is a view illustrating an example in which an artificial intelligence device outputs a notification including information on an operation time of an air cleaner according to an embodiment of the present disclosure.

Referring to FIG. 9, the artificial intelligence device 100 may be a mobile terminal such as a smartphone or a cellular phone.

The artificial intelligence device 100 may display, on the display unit 151, a notification 900 including the operation time of the air cleaner 500, a future fine dust state, text indicating that the air cleaner 500 is turned on.

The artificial intelligence device 100 may output the notification 900 in the form of a push alarm.

The artificial intelligence device 100 may transmit, to the air cleaner 500, a reservation command for performing the air cleaning function of the air cleaner 500 after 5 minutes.

The air cleaner 500 may perform the air cleaning function after 10 minutes according to the received reservation command.

According to the embodiment of the present disclosure, the fine dust state can be maintained in the good state, by accurately grasping fine dust flow in the same area and operating the air cleaner 500.

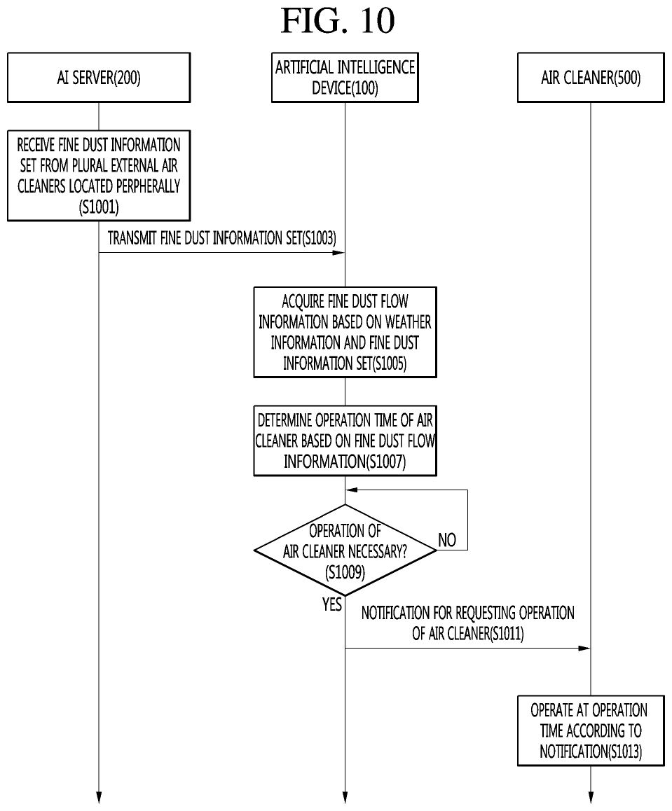

FIG. 10 is a ladder diagram illustrating a method of operating a system according to another embodiment of the present disclosure.

Referring to FIG. 10, the processor 260 of the AI server 200 receives the fine dust information set from the plurality of external air cleaners located peripherally via the communication unit 210 (S1001).

This is replaced with the description of step S501.

The processor 260 of the AI server 200 transmits the fine dust information set to the artificial intelligence device 100 via the communication unit 210 (S1003).

The processor 260 may transmit weather information to the artificial intelligence device 100 along with the fine dust information set.

The processor 180 of the artificial intelligence device 100 acquires the fine dust flow information based on the weather information and the fine dust information set (S1005).

The weather information may be received from the external server or may be acquired from the AI server 200.

The processor 180 of the artificial intelligence device 100 determines the operation time of the air cleaner 500 based on the fine dust flow information (S1007).

The processor 180 of the artificial intelligence device 100 determines whether operation of the air cleaner 500 is necessary based on the determined operation time (S1009).

Upon determining that operation of the air cleaner 500 is necessary, the processor 180 of the artificial intelligence device 100 transmits a notification for requesting operation of the air cleaner 500 to the air cleaner 500 via the communication unit 210 (S1011).

The air cleaner 500 performs the air cleaning operation at the operation time according to the notification received from the artificial intelligence device 100 (S1013).

According to the embodiment of FIG. 10, the process of acquiring the fine dust flow information, the process of determining the operation time of the air cleaner 500 based on the fine dust flow information, the process of determining whether operation of the air cleaner 500 is necessary, etc. may be performed on the artificial intelligence device 100, instead of the AI server 200.

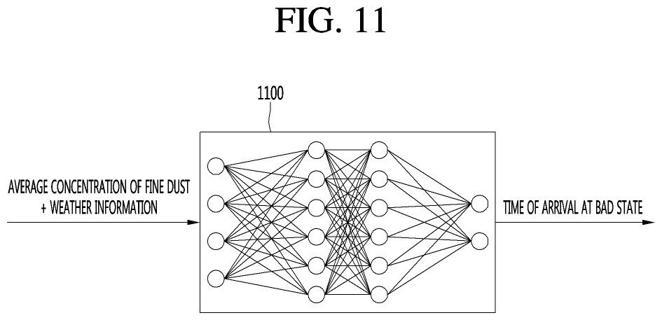

FIG. 11 is a view illustrating an air quality state prediction model according to an embodiment of the present disclosure.

The air quality state prediction model 1100 may refer to a model for inferring a time of arrival at which the fine dust state of the space, in which the air cleaner 500 is located, would be changed to the bad state, using weather information and a fine dust average concentration measured by one or more external air cleaners.

The term including the weather and the fine dust average concentration may be referred to as local air state information.

The air quality state prediction model 1100 may be an artificial neural network based model subjected to supervised learning by a deep learning algorithm or a machine learning algorithm.

The air quality state prediction model 1100 may be learned by the learning processor 240 of the AI server 200 or the learning processor 130 of the artificial intelligence device 100.

When the air quality state prediction model 1100 is learned by the AI server 200, the AI server 200 may transmit the learned air quality state prediction model 1100 to the artificial intelligence device 100.

A training set for learning used for supervised learning of the air quality state prediction model 1100 may include the average concentration of the fine dust concentrations measured by the plurality of external air cleaners, the weather information and a time of arrival at the bad state labeled therein.

That is, the labeling data may include a time of arrival at bad state which is one of the fine dust states.

Assume that, for supervised learning of the air quality state prediction model 1100, the distance d from the air cleaner 500 shown in FIG. 7 or 8 is fixed.

The air quality state prediction model 1100 may be learned and generated separately for each artificial intelligence device 100 located in the house.

The air quality state prediction model 1100 may be a model composed of an artificial neural network trained to infer the time of arrival at the bad state indicating a feature point (or an output feature point) using local air state data as input data.

The air quality state prediction model 1100 may be learned with the aim of accurately inferring the labeled time of arrival at the bad state from information a given local air state.

The loss function (cost function) of the air quality state prediction model 1100 may be expressed by the square mean of a difference between a label for the time of arrival at the bad state corresponding to each training data and the time of arrival at the bad state inferred from each training data.

In addition, in the air quality state prediction model 1100, model parameters included in the artificial neural network to minimize the cost function through learning may be determined.

That is, the air quality state prediction model 1100 is an artificial neural network model subjected to supervised learning using training data including local air state data for learning and the labeled time of arrival at the bad state corresponding thereto.

When an input feature vector is extracted from the local air state data for learning and is input, a result of determination of the time of arrival at the bad state is output as a target feature vector, and the air quality state prediction model 1100 may be trained to minimize the loss function corresponding to the difference between the output target feature vector and the labeled time of arrival.

According to the embodiment of the present disclosure, it is possible to optimally maintain the air quality state of a space in which an air cleaner is located, by operating the air cleaner in advance before the fine dust state is changed to a bad state.

According to the embodiment of the present disclosure, it is possible to protect user's respiratory health, by operating the air cleaner in advance to optimize the air quality state.

The present disclosure may also be embodied as computer readable codes on a computer readable recording medium. The computer readable recording medium is any data storage device that may store data which may be thereafter read by a computer system. Examples of the computer readable recording medium include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof.

What is claimed is:

1. An artificial intelligence device comprising:
a communication interface configured to receive information; and
a processor configured to:
receive, via the communication interface, weather information and a dust information set including dust concentrations measured by one or more external devices located in a space
obtain dust flow information based on the received weather information and the received dust information set, wherein the dust flow information indicates change in a dust state over time in the space in which an air cleaner is located,
determine an operation time of the air cleaner based on the obtained dust flow information, and
transmit, via the communication interface, a notification for requesting operation at the determined operation time to the air cleaner.

2. The device of claim 1, wherein the dust flow information includes a dust state of the space after a certain time.

3. The device of claim 2, wherein the processor is further configured to determine a second time as the operation time of the air cleaner when the dust state is determined to change to an undesirable state after the certain time, wherein the second time is earlier than the certain time.

4. The device of claim 1, wherein the weather information includes a wind direction or a wind speed of the space.

5. The device of claim 1, further comprising an output interface,
wherein the processor is further configured to output, via the output interface, the notification including a reservation notification to perform an air cleaning function of the air cleaner at the operation time.

6. The device of claim 1, further comprising a memory configured to store an air quality state prediction model subjected to supervised learning by a deep learning algorithm or a machine learning algorithm, wherein the air quality state prediction model predicts a time when the dust state of the space is determined to change to an undesirable state.

7. The device of claim 6, wherein the supervised learning is based at least on using a training set including an average value of the dust concentrations measured by the one or more external devices, the weather information, and a determined time period to reach the undesirable state.

8. A method of operating an artificial intelligence device, the method comprising:
receiving weather information and a dust information set including dust concentrations measured by one or more external devices located in a space;
obtaining dust flow information based on the received weather information and the received dust information set, wherein the dust flow information indicates change in dust state over time in a space in which an air cleaner is located;
determining an operation time of the air cleaner based on the obtained dust flow information; and
transmitting, via a communication interface, a notification for requesting operation at the determined operation time to the air cleaner.

9. The method of claim 8, wherein the dust flow information includes a dust state of the space after a certain time.

10. The method of claim 9, wherein the determining the operation time further includes determining a second time as the operation time of the air cleaner when the dust state is determined to be changed to an undesirable state after the certain time, wherein the second time is earlier than the certain time.

11. The method of claim 8, wherein the weather information includes a wind direction or a wind speed of the space.

12. The method of claim 8, further comprising outputting the notification including a reservation notification to perform an air cleaning function of the air cleaner at the operation time.

13. The method of claim 8, further comprising storing an air quality state prediction model subjected to supervised learning by a deep learning algorithm or a machine learning algorithm, wherein the air quality state prediction model predicts a time when the dust state of the space is determined to change to an undesirable state.

14. The method of claim 13, wherein the supervised learning is based at least on a training set including an average value of the dust concentrations measured by one or more external devices, the weather information, and a determined time period to reach the undesirable state.

15. A machine-readable non-transitory medium having stored thereon machine-executable instructions for:
receiving weather information and a dust information set including dust concentrations measured by one or more external devices located in a space;
obtaining dust flow information based on the received weather information and the received dust information set, wherein the dust flow information indicates change in a dust state over time in the space in which an air cleaner is located;
determining an operation time of the air cleaner based on the obtained dust flow information; and
transmitting a notification for requesting operation at the determined operation time to the air cleaner.

16. The machine-readable non-transitory medium of claim 15, wherein the dust flow information includes a dust state of the space after a certain time.

17. The machine-readable non-transitory medium of claim 16, wherein the determining of the operation time further includes determining a second time as the operation time of the air cleaner when the dust state is determined to be changed to an undesirable state after the certain time, wherein the second time is earlier than the certain time.

18. The machine-readable non-transitory medium of claim 15, wherein the weather information includes a wind direction or a wind speed of the space.

19. The machine-readable non-transitory medium of claim 15, wherein the machine-executable instructions further include instructions for:
storing an air quality state prediction model subjected to supervised learning by a deep learning algorithm or a machine learning algorithm, wherein the air quality state prediction model predicts a time when the dust state of the space is determined to change to an undesirable state.

20. The machine-readable non-transitory medium of claim 19, wherein the supervised learning is based at least on a training set including an average value of the dust concentrations measured by one or more external devices, the weather information, and a determined time period to reach the undesirable state.
